(19) United States
(12) Patent Application Publication
(10) Pub. No.: US 2017/0193778 A1
(43) Pub. Date: Jul. 6, 2017

(54) SECURITY TAG LOCATIONING

(71) Applicant: Checkpoint Systems, Inc., Thorofare, NJ (US)

(72) Inventor: Robert Joseph Langer, Delran, NJ (US)

(21) Appl. No.: 14/984,202

(22) Filed: Dec. 30, 2015

(51) Int. Cl. G08B 13/24

(52) U.S. Cl. CPC G08B 13/2462

(57) ABSTRACT

A mobile tag reader that may be configured to wirelessly communicate with a security tag is provided. The mobile tag reader may include a position estimator, which includes processing circuitry configured to receive information indicative of at least a first read event associated with a first antenna beam pattern and a second read event associated with a second antenna beam pattern emitted by the mobile tag reader. The processing circuitry may be further configured to identify an overlap area between at least the first antenna beam pattern and the second antenna beam pattern. The processing circuitry may be further configured to determine an estimated location of the security tag based on the overlap area.

### TECHNICAL FIELD

Various example embodiments relate generally to retail theft deterrent and merchandise protection devices, and more particularly relate to methods and devices for improving location accuracy of security tags employed for such purposes.

### BACKGROUND

Security devices have continued to evolve over time to improve the functional capabilities and reduce the cost of such devices. Some security devices are currently provided to be attached to individual products or objects in order to deter or prevent theft of such products or objects. In some cases, the security devices include tags or other such components that can be detected by gate devices at the exit of a retail establishment or tracked while being moved in the retail establishment. These tags may sometimes also be read for inventory management purposes, and may include or otherwise be associated with specific information about the type of product to which they are attached.

In order to improve the ability of retailers to deter theft or manage inventory, various improvements may be introduced to attempt to improve location accuracy or to carry out certain specific desired functions related to tracking tags which may also be impacted by location accuracy. Thus, the accuracy of determining the location of the tags may be considered to be an important aspect when determining the appropriate balance of characteristics for a given system.

In some cases, the processing power, memory, or other components that impact the capability of systems or devices to handle computational loads may be somewhat limited. Thus, although fairly complex methods for improving location accuracy have been determined in the past, it is important for some applications to choose a locationing method that provides good performance without providing a heavy computational burden on the systems and devices that are available for use.

### BRIEF SUMMARY OF SOME EXAMPLES

Some example embodiments may provide tag locationing that is not only accurate, but also is not computationally burdensome. Accordingly, tag positioning equipment that can provide for accurate locationing of security tags with a relatively low computational cost can be provided.

In one example embodiment, a mobile tag reader that may be configured to wirelessly communicate with a security tag is provided. The mobile tag reader may include a position estimator, which includes processing circuitry configured to receive information indicative of at least a first read event associated with a first antenna beam pattern and a second read event associated with a second antenna beam pattern emitted by the mobile tag reader. The processing circuitry may be further configured to identify an overlap area between at least the first antenna beam pattern and the second antenna beam pattern. The processing circuitry may be further configured to determine an estimated location of the security tag based on the overlap area.

According to another example embodiment, a tag positional estimating system is provided. The system may include at least one security tag disposed on a product in a monitoring environment; and at least one mobile tag reader configured to wirelessly communicate with a security tag. The mobile tag reader may include a position estimator. The position estimator may include a positioning module and processing circuitry. The processing circuitry may be configured to receive information indicative of at least a first read event associated with a first antenna beam pattern and a second read event associated with a second antenna beam pattern emitted by the mobile tag reader. The processing circuitry may be further configured to identify an overlap area between at least the first antenna beam pattern and the second antenna beam pattern. The processing circuitry may be further configured to determine an estimated location of the security tag based on the overlap area.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a conceptual diagram of a monitoring environment within a retail store in which a mobile tag reader may be employed according to an example embodiment;

FIG. 2 illustrates a further conceptual diagram of a monitoring network within a retail store in which a mobile tag reader may be employed in accordance with an example embodiment;

FIGS. 3A-3B illustrates further conceptual diagrams of a monitoring network within a retail store in which a mobile tag reader may be employed in accordance with an example embodiment;

FIG. 4 illustrates a block diagram of a positional estimator located onboard a mobile tag reader according to an example embodiment;

FIG. 5 illustrates a block diagram of a system controller according to an example embodiment; and

FIG. 6 illustrates a block diagram of a method of determining an estimated location of a security tag in accordance with an example embodiment.

### DETAILED DESCRIPTION

Some example embodiments now will be described more fully hereinafter with reference to the accompanying drawings, in which some, but not all embodiments are shown. Indeed, the examples described and pictured herein should not be construed as being limiting as to the scope, applicability, or configuration of the present disclosure. Like reference numerals refer to like elements throughout. Furthermore, as used herein, the term “or” is to be interpreted as a logical operator that results in true whenever one or more of its operands are true. As used herein, “operable coupling” should be understood to relate to direct or indirect connection that, in either case, enables at least a functional interconnection of components that are operably coupled to each other.

As used herein, the terms “component,” “module,” and the like are intended to include a computer-related entity, such as but not limited to hardware, firmware, or a combination of hardware and software. For example, a component or module may be, but is not limited to being, a process running on a processor, a processor, an object, an executable, a thread of execution, or a computer. By way of example, both an application running on a computing device or the computing device can be a component or module. One or more components or modules can reside within a process or thread of execution and a component/module may be localized on one computer or distributed between two or more computers. In addition, these components can execute from various computer readable media having various data structures stored thereon. The components may communicate by way of local or remote processes such as in accordance with a signal having one or more data packets, such as data from one component/module interacting with another component/module in a local system, distributed system, or across a network such as the Internet with other systems by way of the signal. Each respective component/module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the components/modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior or capability of the processing circuitry based on the hardware or software that is added to or otherwise operably coupled to the processing circuitry to configure the processing circuitry accordingly.

Some example embodiments may enable provision of a system and device capable of monitoring, detecting, locating, and estimating a location of security devices (e.g., tags) that are attached to objects, such as retail products. The estimated tag location may be determined for inventory management. The communication between the tag and the mobile tag reader may be referred to as a “read” or “read event”. The process of determining an estimated tag location may be referred to as “locationing” or “tag locationing”. In some cases, the tags may be radio frequency identification (RFID) tags. The tags may be read by a mobile tag reader (e.g., a handheld reader, robot, RFID reader, or the like) to allow the presence of the tag to be detected and identifying information on the tag to be read. The mobile tag reader may be configured to determine the respective estimated location of each of the tags in the monitoring environment. Typically, the mobile tag reader can best determine the estimated location of the tags when reads can be made 360 degrees around each tag; however, tags are often affixed to objects that are located near or on walls or fixtures. Thus, it is impossible for a mobile tag reader to carry out reads 360 degrees around each of the tags, therefore an estimated location of each of the tags may be difficult or impossible to accurately determine. Example embodiments contained herein provide for a tag reader that can accurately determine the estimated location of each the tags in the monitoring environment, even when the tag is affixed to an object that is located near or on a wall or fixture.

In this regard, example embodiments may provide for a tag positional estimating system that can simplify the tag location determining processes employed in the system so that accurate positioning may be accomplished with relatively low computational power, even when the tag is located near or on a wall or fixture in the monitoring environment. In this regard, example embodiments may identify a subset of locating devices or a set of positions from which a mobile locating device has performed a read operation that appear to provide the highest quality position determining capability, and then employ a locating calculation or algorithm that greatly simplifies the location determination process, but still provides a relatively accurate locating result. A lighter-weight and potentially cheaper locating system may therefore be employed while still providing relatively accurate tracking and locating capability. The addition of other functionalities that may be desired may therefore be employed with available resources that would otherwise be consumed by costly calculations associated with tag position determination.

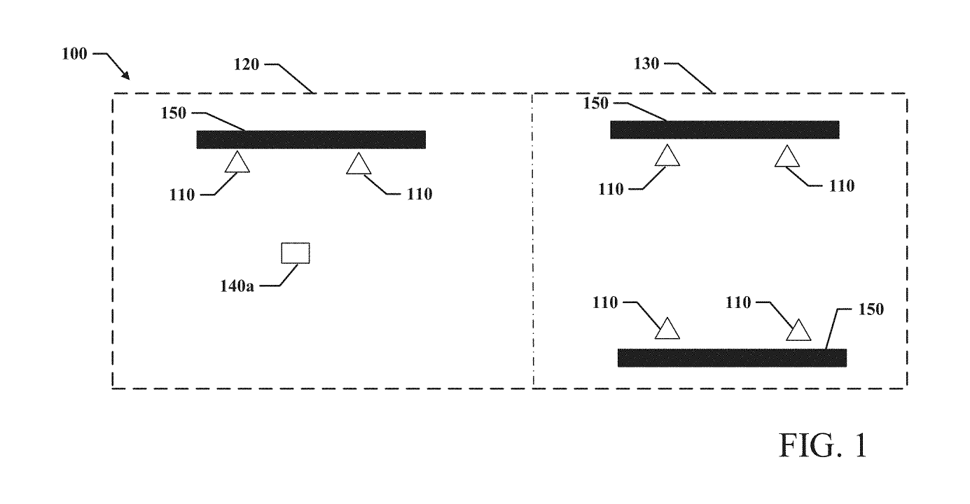

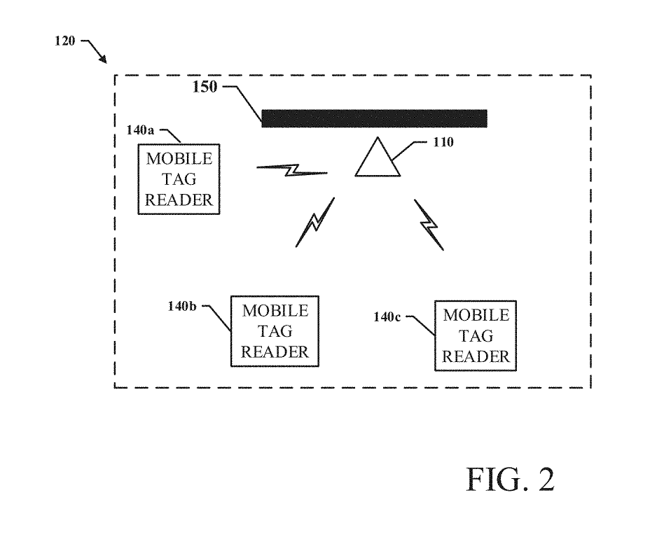

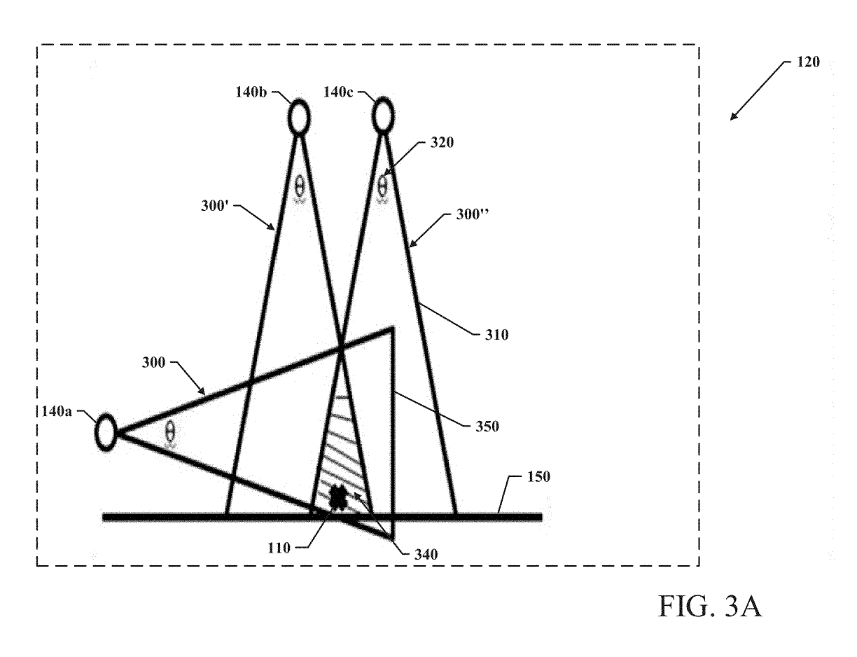

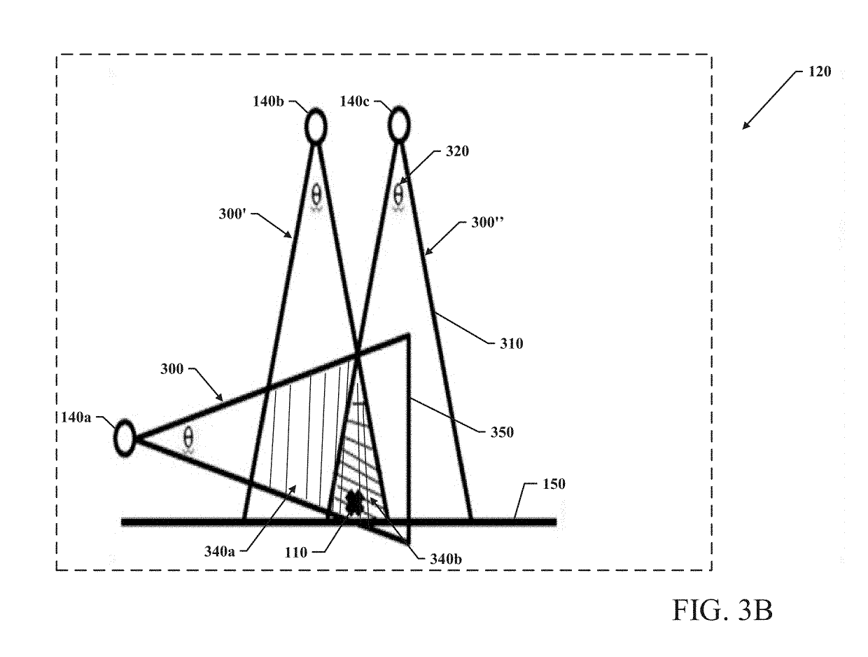

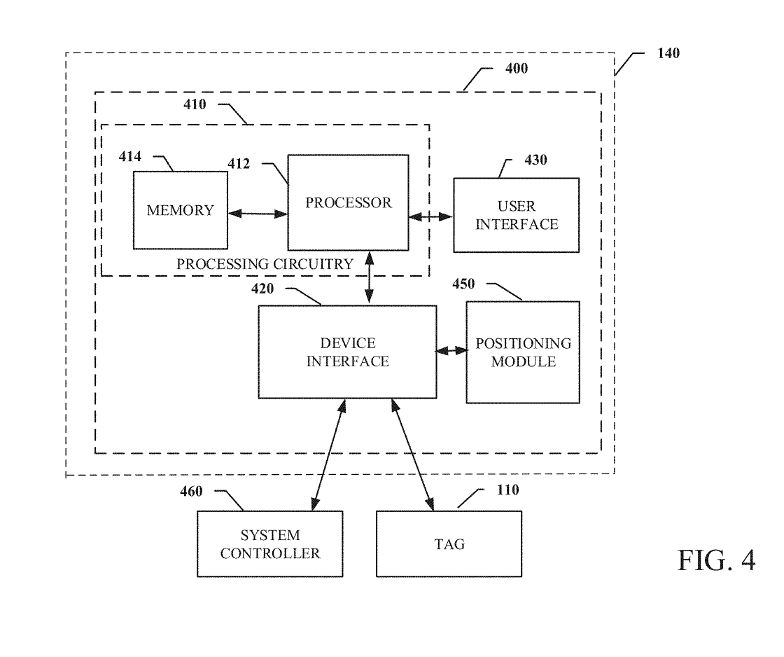

An example embodiment will be described herein as it relates to a mobile tag reader that is configured to wirelessly communicate with a tag in order to determine the estimated location of the tag, even when the tag is located near or on a wall or fixture. FIG. 1 illustrates a conceptual diagram of a monitoring environment 100 within a retail space in which a mobile tag reader 140 may be employed in accordance with an example embodiment. FIG. 2 illustrates a further conceptual diagram of a monitoring environment 100 in which the mobile tag reader 140 may be employed to detect the location of tags 110 within the monitoring environment 100. FIGS. 3A and 3B illustrate even further conceptual diagrams of a monitoring environment 100 in which the mobile tag reader 140 may be employed to detect the location of tags 110 within the monitoring environment in accordance with an example embodiment. FIG. 4 illustrates a block diagram of a positional estimator 400 in accordance with an example embodiment.

As shown in FIG. 1, a mobile tag reader 140 may be used to locate and monitor tags 110 disposed on products that are located near fixture 150 in the monitoring environment 100. The mobile tag reader 140 may be controlled, at least in part, via a position estimator 400 (see FIG. 4) located onboard the mobile tag reader 140. The position estimator 400 may include, among other things, processing circuitry 410 and a positioning module 450 which will be described in greater detail below in reference to FIG. 4.

As further shown in FIG. 1, the monitoring environment 100 may include a first monitoring zone 120 and a second monitoring zone 130. The first monitoring zone 120 may represent one area of the store (e.g., the sales floor). The second monitoring zone 130 may represent another area of the store (e.g., the warehouse or product storage). The first and second monitoring zones 120 and 130 may be exclusively defined or, in some embodiments, the second monitoring zone 130 may exist within and overlap with the first monitoring zone 120. In some embodiments, the monitoring zones 120, 130 may be further divided into sub-zones. The sub-zones may be correlated with specific departments, locations, or product lines within the store, or alternatively be defined to divide the monitoring environment 100 into conveniently defined regions to facilitate detecting and locating tags 110 within particular regions. Even further, the monitoring environment 100 and respective monitoring zones 120, 130 and subzones may each be converted into a coordinate system such as a Cartesian coordinate system to facilitate the location determination process.

The mobile tag reader 140 may move throughout the first and second monitoring zones 120 and 130 and detect and communicate with the tags 110 located in such zones. The mobile tag reader 140 may communicate with the tag 110 from only a first position 140a in the monitoring zone, as shown in FIG. 1, in order to determine the location of the tag 110. In particular, the mobile tag reader 140 may communicate with the tag 110 from a first position 140a when the mobile tag reader 140 includes multiple antennas, where the multiple antennas have different characteristics resulting in an overlap area of each antenna's respective antenna beam pattern.

However, as shown in FIG. 2, in some cases, the mobile tag reader 140 may only have one antenna and may have to communicate with the tag 140 from a plurality of positions in the monitoring zone 100 in order to facilitate determining the location of the tag 110. For example, the mobile tag reader 140 may communicate with the tag 110 disposed on the fixture 150 in the first monitoring zone 120 from a plurality of positions that may include a first position 140a, a second position 140b, and a third position 140c. The communication between the mobile tag reader 140 and the tag 110 may be based on wireless communications.

As shown in FIG. 3A, in order to determine the estimated location of the tag 110, the mobile tag reader 140 may emit a known antenna beam pattern 300 from the plurality of positions 140a, 140b, and 140c in the monitoring environment 100 to read or communicate with the tag 110. In particular, if the mobile tag reader 140 has only one antenna, the mobile tag reader 140 may be configured to move to the first position 140a and emit the known antenna beam pattern 300, then the second position 140b and emit the known beam pattern 300′, and finally the third position 140c in the monitoring environment 100 to emit the known antenna beam pattern 300″. In some cases, the known antenna beam patterns 300, 300′, and 300″ are the same beam patterns. Based on the read events of the tag 110 from the first, second, and third positions 140a, 140b, and 140c taken at different times, an estimated location of the tag 110 may be determined.

In further example embodiments, if the mobile tag reader 140 has multiple antennas, the mobile tag reader 140 may be configured to emit a known antenna beam pattern from each antenna at the same time in order to communicate with the tag 110. In some cases, each of the known antenna beam patterns emitted from the different antennas are different. According to some example embodiments, each antenna may have relative spacial diversity from the other antennas thereby permitting the emission of multiple beam patterns simultaneously. Whether one antenna or a plurality of antennas are performing multiple reads of the tag 110, at least two reads of the tag 110 must be performed in order to determine the estimated location of the tag 110. However, in further example embodiments, more than two reads of the tag 110 may be performed by the mobile tag reader 140 in order to determine the estimated location of the tag 110.

As further shown in FIG. 3A, in some cases, the antenna beam pattern 300 may be formed by two lateral sides 310. The two lateral sides 310 may form a pre-defined angle 320. In some cases, the angle 320 may be a 45 degree angle; however, in other example embodiments, the angle 320 may be less than 45 degrees. The distance the lateral sides 310 extend may be determined by signal strength, as further discussed below, such that the antenna beam pattern 300 extends a maximum range 350. By knowing the antenna beam pattern 300 of the antennas of the mobile tag reader 140 and detecting the read event of the tag 110 in each of the antenna beam patterns 300 emitted, an overlap area 340 between the antenna beam patterns 300 emitted may be identified. This identified overlap area 340 may represent the estimated location of the tag 110.

As illustrated in FIG. 3B, when the mobile tag reader 140 emits a known beam pattern 300 from a first position 140a and then emits a known beam pattern 300′ from a second position 140b, the estimated location of the tag 110 could be determined based on the resulting overlap area 340a. However, by the mobile tag reader 140 emitting a known beam pattern 300″ from a third position 140c, the resulting overlap area 340b is a more effectively narrowed overlap area 340b, thereby more effectively facilitating a location determination of the tag 110. Thereby, the mobile tag reader 140, or the position estimator 400, may be configured to determine if more read events of the tag 110 are needed to more accurately determine the estimated location of the tag 110.

Various of technology may be employed by the mobile tag reader 140 in order to read or communicate with the tag 110. For example, angle of arrival (AOA) technology may be used. The mobile tag reader 140 may include at least one antenna and may be configured to read signals transmitted by the tag 110. Even further, received signal strength indication (RSSI) technology may be used by the mobile tag reader 140. The mobile tag reader 140 may include at least one antenna and may be configured to determine the power levels of signals transmitted by the tag 110 to use RSSI to communicate with the tag 110.

FIG. 4 illustrates a block diagram of a position estimator 400 located onboard the mobile tag reader 140. The position estimator 400 may be configured to determine an estimated location of the tag 110 located in a monitoring environment 100 in accordance with an example embodiment. In particular, the position estimator 400 may be configured to identify the overlap area 340 resulting when at least two read events of the tag 110 are detected by the mobile tag reader 140 in the monitoring environment 100. In a further example embodiment, the position estimator 400 may be configured to define the length or distance of the lateral sides 310 of the known antenna pattern 300 based on signal strength received from the tag 110. In some cases, the signal strength may be based on RSSI technology. In a further example embodiment, the distance of the lateral sides 310 may be based on estimating the AOA. If, for example, RSSI is used to determine the distance of the lateral sides 310, the position estimator 400 may be configured to weight RSSI measurements associated with the read event of the tag 110 prior to determining the estimated position of the tag 110. The position estimator 400, in further example embodiments, may be configured to determine the x,y coordinates associated with the overlap area 310, and more particularly, the x,y coordinates associated with the estimated location of tag 110.

In an example embodiment, the position estimator 400 may be located onboard a handheld version of the mobile tag reader 140. In another example embodiment, the position estimator 400 may be located on a robot that includes or otherwise embodies the mobile tag reader 140, where the robot also includes a mobility assembly that is guided by the position estimator 400.

As shown in FIG. 4, the position estimator 400 may include processing circuitry 410 configured in accordance with an example embodiment as described herein. In this regard, for example, the position estimator 400 may utilize the processing circuitry 410 to provide electronic control inputs to one or more functional units of the position estimator 400 to receive, transmit, or process data associated with the one or more functional units and perform communications necessary to enable detecting, monitoring, and locationing of tags 110, or the like as described herein. In some embodiments, the processing circuitry 410 may be embodied as a chip or chip set. In other words, the processing circuitry 410 may comprise one or more physical packages (e.g., chips) including materials, components, or wires on a structural assembly (e.g., a baseboard). The structural assembly may provide physical strength, conservation of size, or limitation of electrical interaction for component circuitry included thereon. The processing circuitry 410 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 410 may include one or more instances of a processor 412 and memory 414 that may be in communication with or otherwise control a device interface 420. As such, the processing circuitry 410 may be embodied as a circuit chip (e.g., an integrated circuit chip) configured (e.g., with hardware, software, or a combination of hardware and software) to perform operations described herein.

The device interface 420 may include one or more interface mechanisms for enabling communication with other devices (e.g., tag 110, system controller 460, or other devices). In some cases, the device interface 420 may be any means such as a device or circuitry embodied in either hardware, or a combination of hardware and software that is configured to receive or transmit data from/to devices or components in communication with the processing circuitry 410 via internal or external communication mechanisms. Accordingly, for example, the device interface 420 may further include wireless communication equipment (e.g., one or more antennas) for at least communicating with tags 110 or a system controller 460. The device interface 420 may therefore include one or more antenna arrays that may be configured or configurable to receive or transmit properly formatted signals associated with the tags 110 or the system controller 460. The device interface 420 may further include radio circuitry configured to encode or decode, modulate or demodulate, or otherwise process wireless signals received by or to be transmitted by the antenna array(s).

The processor 412 may be embodied in a number of different ways. For example, the processor 412 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 412 may be configured to execute instructions stored in the memory 414 or otherwise accessible to the processor 412. As such, whether configured by hardware or by a combination of hardware and software, the processor 412 may represent an entity (e.g., physically embodied in circuitry—in the form of processing circuitry 410) capable of performing operations according to embodiments of the present invention while configured accordingly. Thus, for example, when the processor 412 is embodied as an ASIC, FPGA or the like, the processor 412 may be specifically configured hardware for conducting the operations described herein. Alternatively, as another example, when the processor 412 is embodied as an executor of software instructions, the instructions may specifically configure the processor 412 to perform the operations described herein in reference to execution of an example embodiment.

In some examples, the processor 412 (or the processing circuitry 410) may be embodied as, include or otherwise control the operation of the position estimator 400 based on inputs received by the processing circuitry 410. As such, in some embodiments, the processor 412 (or the processing circuitry 410) may be said to cause each of the operations described in connection with the position estimator 400 in relation to operation of the position estimator 400 relative to undertaking the corresponding functionalities associated therewith responsive to execution of instructions or algorithms configuring the processor 412 (or processing circuitry 410) accordingly. In particular, the processor 412 (or processing circuitry 410) may be configured to enable the position estimator 400 to communicate with the tag 110 to provide information to the system controller 460 that enables the system controller 460 to perform other functions based on the monitoring, detecting, and locationing of the tag 110 or other information received from the position estimator 400 that is determinable from the communications with the position estimator 400.

In an exemplary embodiment, the memory 414 may include one or more non-transitory memory devices such as, for example, volatile or non-volatile memory that may be either fixed or removable. The memory 414 may be configured to store information, data, applications, instructions, or the like for enabling the processing circuitry 410 to carry out various functions in accordance with exemplary embodiments of the present invention. For example, the memory 414 may be configured to buffer input data for processing by the processor 412. Additionally or alternatively, the memory 414 may be configured to store instructions for execution by the processor 412. As yet another alternative or additional capability, the memory 414 may include one or more databases that may store a variety of data sets or tables useful for operation of the position estimator 400. Among the contents of the memory 414, applications or instruction sets may be stored for execution by the processor 412 in order to carry out the functionality associated with each respective application or instruction set. In some cases, the applications/instruction sets may include instructions for carrying out some or all of the operations described in reference to the calculations, algorithms, or flow charts described herein. In particular, the memory 414 may store executable instructions that enable the computational power of the processing circuitry 410 to be employed to improve the functioning of the position estimator 400 relative to the functions described herein. As such, the improved operation of the computational components of the position estimator 400 transforms the position estimator 400 into a more capable tracking, notifying, and locating device relative to the physical objects to which the tag 110 is attached. The processing circuitry 410 may therefore be configured (e.g., by instruction execution) to receive signals from the mobile tag reader 140 and transform attributes of the received signals into data describing the location of the tags 110 for presentation to a user on a terminal or to trigger other functionalities of the mobile tag reader 140.

In an example embodiment, the position estimator 400 may include a positioning module 450. The position estimator 400 may utilize the positioning module 450 to determine the position of the mobile tag reader 140 and define the navigational path of the mobile tag reader 140 as it moves throughout monitoring environment 100. Positional determinations of the mobile tag reader 140 may be made using an accelerometer measuring direction and distance from a known location (e.g., a charging station), GPS, Bluetooth, locating beacons, visual location, LIDAR, or other positioning techniques or combinations thereof.

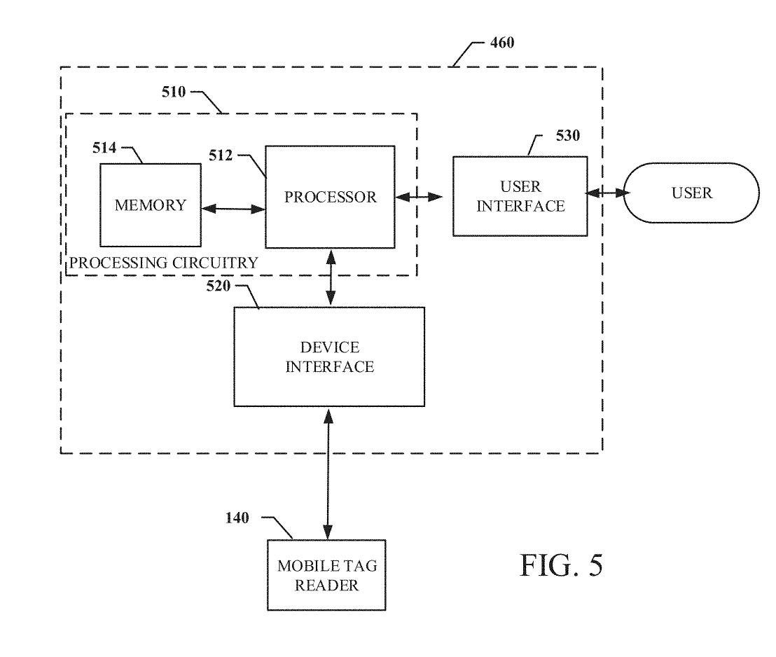

FIG. 5 illustrates a block diagram of the system controller 460 in accordance with an example embodiment. The system controller 460 may be configured to communicate with a plurality of mobile tag readers 140. As shown in FIG. 5, the system controller 460 may include processing circuitry 510 of an example embodiment as described herein. In this regard, for example, the system controller 460 may utilize the processing circuitry 510 to provide electronic control inputs to one or more functional units of the system controller 460 to obtain, transmit, or process data associated with the one or more functional units and perform the communications necessary to enable tracking, notifying, locating, or the like described herein. The system controller 460 may also initiate and control the processing of tag 110 location information to perform tag location estimation, as described above.

In some embodiments, the processing circuitry 510 may be embodied in physical and functional form in a similar manner to that which has been described above. However, according to some example embodiments, the processing circuitry 510 may have expanded capabilities with respect to processing speed and communication throughput relative to the processing circuitry 410 utilized by the position estimator 400. For example, the system controller may be configured to receive data from multiple tag readers 140 located within different monitoring zones in a monitoring environment 100. In particular, the system controller 460 may receive data from multiple tag readers 140 and may simultaneously estimate the location of multiple tags 110 located in multiple monitoring zones in a monitoring environment 100 based on the data received from the multiple tag readers 140.

The system controller 460 may be configured to execute the operations described above for the position estimator 400 embodied at the mobile tag reader 140. When the position estimator 400 is not implemented at the system controller 460, the position estimator 400 may process information remotely and act accordingly based on the information. When the position estimator 400 and the system controller 460 split functions, the position estimator 400 and system controller 460 may communicate cooperatively to execute example embodiments. From a technical perspective, processing circuitry embodied at the position estimator 400 or either at the system controller 460 described above may be used to support some or all of the operations described above.

As such, the platforms described in FIGS. 1-6 may be used to facilitate the implementation of several computer program or network communication based interactions. As an example, FIG. 7 is a flowchart of an example method according to an example embodiment. It will be understood that each block of the flowcharts, and combinations of blocks in the flowcharts, may be implemented by various means, such as hardware, firmware, processor, circuitry or other device associated with execution of software including one or more computer program instructions. For example, one or more of the procedures described above may be embodied by computer program instructions. In this regard, the computer program instructions which embody the procedures described above may be stored by a memory device of a computing device and executed by a processor in the computing device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

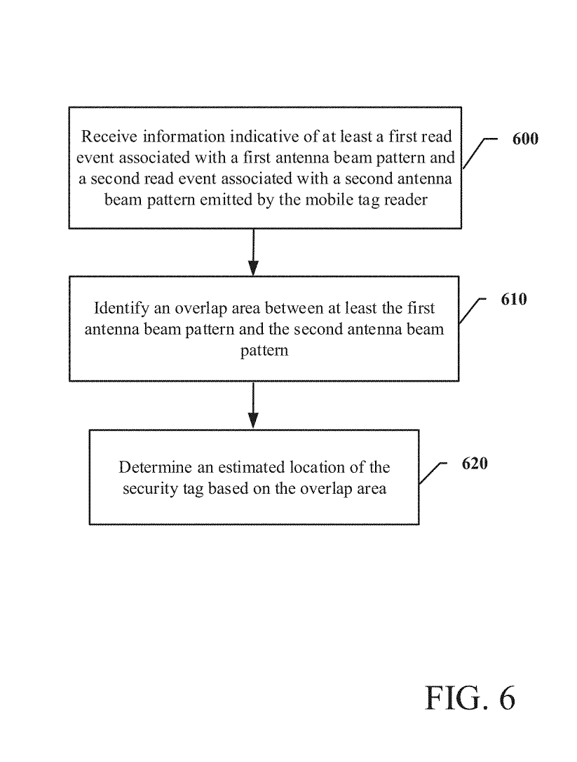

In this regard, FIG. 6 illustrates a block diagram of a method of determining an estimated location of the security tag 110 in accordance with an example embodiment. As shown in FIG. 4, the processing circuitry 410 of the position estimator 400 (or the processing circuitry 510 of the system controller 460) may initially receive information indicative of at least a first read event associated with a first antenna beam pattern and a second read event associated with a second antenna beam pattern emitted by the mobile tag reader at operation 600. The process circuitry may then identify an overlap area between at least the first antenna beam pattern and the second antenna beam pattern at operation 610. Any time/strength weighting of the measurements needed (e.g. if the detection of the security tag within the antenna beam is based on signal strength) may then be applied at operation 610. At operation 620, the estimated location of the security tag is determined based on the overlap area.

In some embodiments, the features described above may be augmented or modified, or additional features may be added. These augmentations, modifications and additions may be optional and may be provided in any combination. Thus, although some example modifications, augmentations and additions are listed below, it should be appreciated that any of the modifications, augmentations and additions could be implemented individually or in combination with one or more, or even all of the other modifications, augmentations and additions that are listed. As such, for example, the first antenna beam pattern and the second antenna beam pattern may be a same beam pattern. In some cases, the first antenna beam pattern and the second antenna beam pattern are emitted at different times. Alternatively or additionally, the first antenna beam pattern and the second antenna beam pattern may be different beam patterns. In some cases, the first antenna beam pattern and the second antenna beam pattern are emitted at a same time. In some example embodiments, the first antenna beam pattern and the second antenna beam pattern may each further include two lateral sides that have a pre-defined distance and form less than about a 45 degree angle. In some cases, the pre-defined distance is based on signal strength. Alternatively or additionally, the signal strength is determined based on RSSI. Alternatively or additionally, the processing circuitry is further configured to weight RSSI of the security tag prior to calculating the estimated location of the security tag. In an example embodiment, the processing circuitry is further configured to receive information indicative of at least three read events, wherein each read event is associated with a respective antenna beam pattern emitted by the mobile tag reader on a same side relative to the security tag. Alternatively or additionally, the mobile tag reader may be handheld. Alternatively or additionally, the mobile tag reader may be a robot. Therefore, example embodiments may provide for a tag positional estimating system that can simplify the tag location determining processes employed in the system so that accurate positioning may be accomplished with relatively low computational power, even when the tag is located near or on a wall or fixture in the monitoring environment.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements or functions, it should be appreciated that different combinations of elements or functions may be provided by alternative embodiments without departing from the scope of the appended claims. In this regard, for example, different combinations of elements or functions than those explicitly described above are also contemplated as may be set forth in some of the appended claims. In cases where advantages, benefits or solutions to problems are described herein, it should be appreciated that such advantages, benefits or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A mobile tag reader configured to wirelessly communicate with a security tag, the mobile tag reader comprising a position estimator including processing circuitry configured to:
receive information indicative of at least a first read event associated with a first antenna beam pattern and a second read event associated with a second antenna beam pattern emitted by the mobile tag reader;
identify an overlap area between at least the first antenna beam pattern and the second antenna beam pattern; and
determine an estimated location of the security tag based on the overlap area.

2. The mobile tag reader of claim 1, wherein the first antenna beam pattern and the second antenna beam pattern are a same beam pattern.

3. The mobile tag reader of claim 2, wherein the first antenna beam pattern and the second antenna beam pattern are emitted at different times.

4. The mobile tag reader of claim 1, wherein the first antenna beam pattern and the second antenna beam pattern are different beam patterns.

5. The mobile tag reader of claim 4, wherein the first antenna beam pattern and the second antenna beam pattern are emitted at a same time.

6. The mobile tag reader of claim 1, wherein each of the first antenna beam pattern and the second antenna beam pattern are comprised of two lateral sides that have a pre-defined distance and form less than about a 45 degree angle.

7. The mobile tag reader of claim 6, wherein the pre-defined distance is based on signal strength.

8. The mobile tag reader of claim 7, wherein the signal strength is determined based on a received signal strength indication (RSSI).

9. The mobile tag reader of claim 8, wherein the processing circuitry is further configured to weight the RSSI of the security tag prior to calculating the estimated location of the security tag.

10. The mobile tag reader of claim 1, wherein the processing circuitry is further configured to receive information indicative of at least three read events, wherein each read event is associated with a respective antenna beam pattern emitted by the mobile tag reader on a same side relative to the security tag.

11. The mobile tag reader of claim 1, wherein the mobile tag reader is handheld.

12. The mobile tag reader of claim 1, wherein the mobile tag reader is a robot.

13. A tag positional estimating system comprising:
at least one security tag disposed on a product in a monitoring environment; and
at least one mobile tag reader configured to wirelessly communicate with a security tag, the mobile tag reader comprising:
a position estimator comprising:
a positioning module; and
processing circuitry configured to:
receive information indicative of at least a first read event associated with a first antenna beam pattern and a second read event associated with a second antenna beam pattern emitted by the mobile tag reader;
identify an overlap area between at least the first antenna beam pattern and the second antenna beam pattern; and
determine an estimated location of the security tag based on the overlap area.

14. The system of claim 13, wherein the first antenna beam pattern and the second antenna beam pattern are a same beam pattern.

15. The system of claim 14, wherein the first antenna beam pattern and the second antenna beam pattern are emitted at different times.

16. The system of claim 13, wherein the first antenna beam pattern and the second antenna beam pattern are different beam patterns.

17. The system of claim 16, wherein the first antenna beam pattern and the second antenna beam pattern are emitted at a same time.

18. The system of claim 13, wherein the first antenna beam pattern and the second antenna beam pattern have a pre-defined distance and are comprised of two lateral sides that form less than about a 45 degree angle.

19. The system of claim 18, wherein the pre-defined distance is based on signal strength.

20. The system of claim 19, wherein the signal strength is determined based on RSSI.
